(19) United States
(12) Patent Application Publication
(10) Pub. No.: US 2021/0356306 A1
(43) Pub. Date: Nov. 18, 2021

(54) ATOMIC TAGGING VELOCIMETRY METHOD AND SYSTEM

(71) Applicant: THE TRUSTEES OF THE STEVENS INSTITUTE OF TECHNOLOGY, Hoboken, NJ (US)

(72) Inventor: Nick Parziale, Ridgewood, NJ (US)

(73) Assignee: THE TRUSTEES OF THE STEVENS INSTITUTE OF TECHNOLOGY, Hoboken, NJ (US)

(21) Appl. No.: 17/320,112

(22) Filed: May 13, 2021

Related U.S. Application Data
(60) Provisional application No. 63/024,344, filed on May 13, 2020.

(51) Int. Cl. G01F 1/704; G06T 7/246

(52) U.S. Cl. CPC G01F 1/704; G06T 7/248

(57) ABSTRACT

Methods and apparatus for tracking fluid flows are disclosed. Fast-moving fluids can be non-invasively tracked, including those at supersonic and hypersonic speeds. To track such flows, atoms of an inert gas can be introduced into the fluid. To monitor the tracer, a laser excites a series of molecules along a “write line,” which can be tracked by a series of cameras in order to estimate flow velocity.

### CROSS-REFERENCE TO RELATED APPLICATION

This application claims priority to U.S. Provisional Patent Application No. 63/024,344 filed May 13, 2020, the entire disclosure of which is incorporated herein by reference.

### STATEMENT OF GOVERNMENT INTEREST

This invention was made with government support under Grant Numbers FA9550-16-1-0262, FA9550-15-1-0325, FA9550-18-1-0403, and FA9550-19-1-0182 awarded by the Air Force Office of Scientific Research (USAF/AFOSR); N00014-20-1-2637, N00014-20-1-2682, and N00014-20-1-2549 awarded by the Office of Naval Research; and FA2487-19-C-0013 and FA9101-17-P-0094 awarded by Air Force Small Business Innovation Research. The government has certain rights in the invention.

### FIELD OF THE INVENTION

The present the invention pertains to measurement of flow, and, more specifically, a technique for measuring high speed particles.

### BACKGROUND OF THE INVENTION

Atomic tagging velocimetry is a measurement technique that enables high-fidelity measurement of fluid flows. Current applications include measurement of supersonic and hypersonic fluid flows.

There are a few known methods of performing atomic tagging velocimetry. Universal to all of these is seeding a base fluid flow with a trace amount of a noble gas so as to not disturb the flow. Methodologies for making velocity measurements in fluid flows include pressure-based measurement, thermal anemometry, and particle-based techniques such as laser-Doppler velocimetry, global-Doppler velocimetry, and particle image velocimetry (M). The measurement of velocity with pressure-based and thermal anemometry methods is refined in that such methods consistently yield data with low uncertainty; however, these techniques are intrusive, which eliminates them as candidates in certain flow regimes. With respect to PIV, in particular, at high Mach number, the particles do not track the flow of the measured fluid, making any associated measurement inaccurate. Pitot probes are another option, which indirectly measure velocity by way of making pressure measurements. However, frequency response, spatial resolution, and the extent of the required assumptions regarding the local temperature constitute limitations. Particle-based methods of velocimetry, especially PIV, can produce high-quality, multi-component velocity data; in addition, PIV can yield field information about vorticity and pressure after further data processing. However, the limitations of implementing particle-based techniques in high-speed facilities include timing issues associated with particle injection and reduced particle response at Knudsen and Reynolds numbers typical of high-speed wind tunnels.

### SUMMARY

The present invention relates to a methodology and system for making non-contact velocity measurements. The methods of the present invention are particularly well-adapted for velocity measurement in supersonic and hypersonic wind tunnels. Fundamentally, atomic tagging velocimetry addresses the particle lag response problem outlined above, as experienced by particle-based techniques in flows at supersonic and hypersonic Mach number speeds, which tends to result in failure of the seeded particles to properly track the flow.

Atomic tagging velocimetry is different from molecular tagging velocimetry mainly because of the agent being tagged: an atom as opposed to a molecule. The method of the present invention utilizes an atomic tracer as opposed to a molecular tracer. In contrast to previous techniques, the signal-to-noise ratio is higher and the tracer is inert making it safe to handle in the lab. While prior techniques, such as FLEET (i.e., molecular tagging velocimetry) do not require the seeding of a noble gas, the signal tends to be weaker than with the methods of the present invention.

Fundamentally, the present invention represents a promising opportunity for technological advancement. With this process, fluid mechanical phenomena that were previously inaccessible may be explored in depth.

The process to measure fluid velocity, which could be conducted in a wind-tunnel or another enclosed space, involves introducing inert tracer atoms into a fluid, such as atoms of a noble gas (e.g., Krypton, Argon, etc.), exciting a write line of atoms with a laser or other suitable means, imaging the write line (e.g., with a charge-coupled device camera) as a first image, waiting for a predetermined delay period (e.g., from about 500 ns to 2 about μs) such that said write line translates in the enclosed space and becomes a read line, imaging the read line (e.g., via an equivalent CCD camera or through other means) as a second image, and calculating the fluid velocity by comparing the first and second images.

Alternatively the process to measure fluid velocity can involve introducing inert tracer atoms into a fluid, exciting a write line of atoms, imaging the write line as a first image, waiting for a predetermined delay period (e.g., from about 500 ns to 2 about μs) such that the write line translates in space, re-exciting the translated write-line (e.g., with a laser) such that the translated write line becomes a read line, imaging the read line as a second image, and calculating the fluid velocity by comparing the first and second images. The inventive techniques enable the measurement of even supersonic and hypersonic fluid speeds in wind tunnels.

### BRIEF DESCRIPTION OF FIGURES

For a better understanding of the present invention, reference is made to the following detailed description of various exemplary embodiments considered in conjunction with the accompanying drawings, in which like structures are referred to by the like reference numerals throughout the several views, and in which:

FIG. 1 is a general schematic outline of the process of the present invention;

FIG. 2 is a diagram illustrating energy level transition dynamics for krypton gas in accordance with one embodiment of the present invention;

FIG. 3 is a diagram illustrating energy level transition dynamics for krypton gas in accordance with another embodiment of the present invention; and

FIG. 4 is a system diagram of an exemplary apparatus useful in practicing the present invention.

### DETAILED DESCRIPTION OF EXEMPLARY EMBODIMENTS

Reference will now be made to several embodiments of the present invention(s), examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

All terms defined herein should be afforded their broadest possible interpretation, including any implied meanings as dictated by a reading of the specification as well as any words that a person having skill in the art and/or a dictionary, treatise, or similar authority would assign thereto. The term “write line” as used herein refers to a given population of excited atoms. Likewise, the term “read line” refers to the write line atoms translated in space and/or re-excited.

The terms, “for example”, “e.g.”, “optionally”, as used herein, are intended to be used to introduce non-limiting examples. The phrases “in one embodiment” and “in some embodiments” as used herein do not necessarily refer to the same embodiment(s), though they may. Furthermore, the phrases “in another embodiment” and “in some other embodiments” as used herein do not necessarily refer to a different embodiment, although they may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” includes plural references. The meaning of “in” includes “in” and “on.” In addition, the terms “comprises” and “comprising” when used herein specify that certain features are present in that embodiment, however, this phrase should not be interpreted to preclude the presence or addition of additional steps, operations, features, components, and/or groups thereof.

Before describing the aforementioned figures, it should be noted that the use of atomic noble-gas species for diagnostics is unique because such species are nominally thermochemically inactive at atmospheric or typical high-speed, wind-tunnel flow conditions. In addition, such species are safe and able to be implemented in practice, given that they do not distort the mean flow of interest when introduced in dilute concentrations. That is, there is the potential for implementation in flows where the thermochemical state of the gas or fluid is difficult to prescribe or predict.

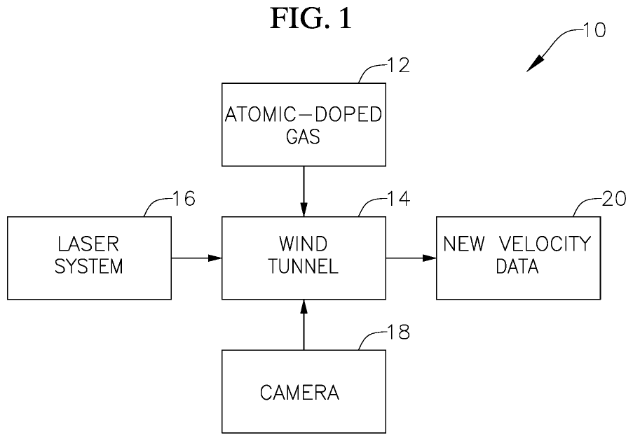

Turning now to the figures themselves, FIG. 1 is a schematic diagram of a method for measuring fluid flows. In a first exemplary embodiment, the method 10 for velocimetry in a fluid of interest involves a first step 12 of seeding trace noble gas tracer atoms in the fluid, which fluid is flowing in a wind tunnel 14. These tracer atoms are then tagged using a laser (i.e., laser line) and/or laser system 16 to form a “write line” of excited atoms (i.e., laser-induced fluorescence). A camera 18, such as that sold under the name “PIMAX4” by Princeton Instruments, or another intensified charge-coupled device (CCD) camera with appropriate sensitivity, is then used to image the “write line” as a first image. Following a brief time delay (e.g., 500 ns to 2 us), the “write line” will have been slightly translated as a result of motion of the fluid, becoming a “read line.” This “read line” is imaged by the camera 18 to generate a second image. As a result of post-processing performed on the two images, the translation of the “write line” can be calculated and data 20 generated that pertain to the velocity of the fluid in the wind tunnel 14.

In a second exemplary embodiment, the method for velocimetry in a fluid of interest also performs step 12 (i.e., the seeding of noble gas tracer atoms in the fluid). As in the first exemplary embodiment, these atoms are then tagged with laser system 16 to form a “write line” of excited atoms. A camera, which can be the same camera 18 described above, is then used to image the “write line” as a first image. Following a brief time delay (e.g., 500 ns to 2 us), the “write line” will have been translated as a result of motion of the fluid. At this point in time, the atoms of the translated “write line” are re-excited by laser system 16 in order to obtain a “read line.” This “read line” is imaged by the camera 18 to generate a second image. As a result of post-processing performed on the two images, the translation of the “write line” can be calculated and data 20 generated to determine the velocity of the fluid. While the re-excitation step may be more complex in implementation relative to the previous method described above, it is expected that the signal (i.e., “read line”) will be more prominent.

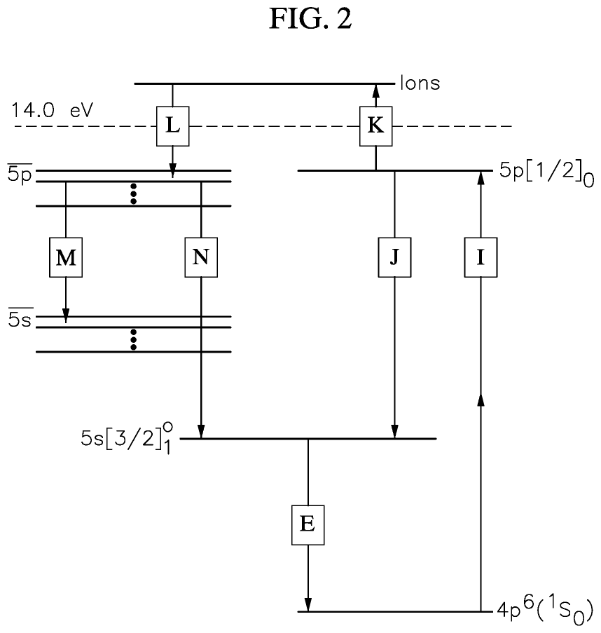

FIG. 2 is schematic illustration of possible energy level transition dynamics for krypton gas associated with the first exemplary embodiment. However, other monatomic gases (e.g., argon) can be potentially substituted. The horizontal bars represent energy levels, the arrows represent atomic transitions, and the letters correspond to specific wavelengths.

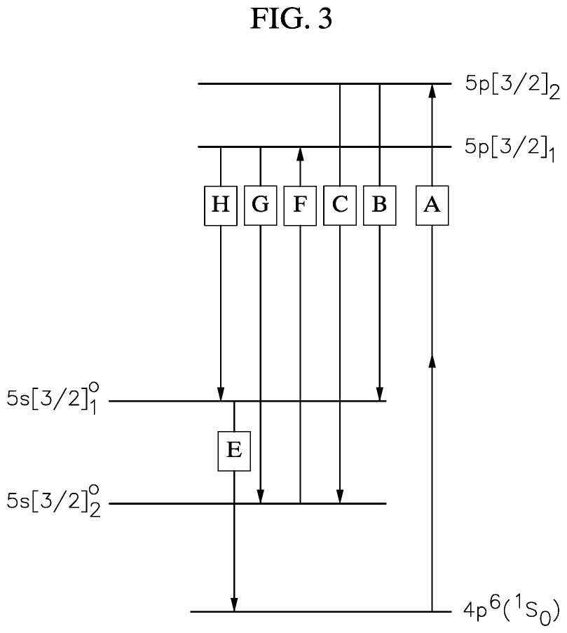

FIG. 3 is schematic illustration of possible energy level transition dynamics for krypton gas associated with the second exemplary embodiment described hereinabove. However, other monatomic gases (e.g., argon) can be potentially substituted. The horizontal bars represent energy levels, the arrows represent atomic transitions, and the letters correspond to specific wavelengths.

Table 1 (see below) is a table listing various physical properties associated with the energy level transitions depicted in FIGS. 2 and 3.

TABLE 1

| TRANSITION | λ_{AIR} | NATURE | Aij | Ej | Ei | LOWER LEVEL | UPPER LEVEL |
|---|---|---|---|---|---|---|---|
| (—) | (nm) | (—) | (s⁻¹) | (cm⁻¹) | (cm⁻¹) | (—) | (—) |
| A | 214.77 | TWO-PHOTON | (—) | 0 | 93123.34 | 4s²4p⁶,¹s₀ | 5p[3/2]₂ |
| B | 819.00 | SINGLE-PHOTON | 1.1e7 | 80916.77 | 93123.34 | 5s[3/2]₁⁰ | 5p[3/2]₂ |
| C | 760.15 | SINGLE-PHOTON | 3.1e7 | 79971.74 | 93123.34 | 5s[3/2]₂⁰ | 5p[3/2]₂ |
| D | 760.15 | SINGLE-PHOTON | (—) | 79971.74 | 93123.34 | 5s[3/2]₂⁰ | 5p[3/2]₂ |
| E | 123.58 | SINGLE-PHOTON | 2.98e8 | 0 | 80916.77 | 4s²4p⁶,¹s₀ | 5s[3/2]₁⁰ |
| G | 769.45 | SINGLE-PHOTON | 5.6e6 | 79971.74 | 92954.39 | 5s[3/2]₂⁰ | 5p[3/2]₁ |
| H | 829.81 | SINGLE-PHOTON | 3.2e7 | 80916.77 | 92954.39 | 5s[3/2]₁⁰ | 5p[3/2]₁ |
| M/N | 750-830 | SINGLE-PHOTON | 1e6 − 1e7 | 80000 | 90000 | 5̅s̅ | 5̅p̅ |
| I | 212.556 | TWO-PHOTON | (—) | 0 | 94092.86 | 4s²4p⁶,¹s₀ | 5p[1/2]₀ |
| J | 758.74 | SINGLE-PHOTON | 4.3e7 | 80916.77 | 94092.86 | 5s[3/2]₁⁰ | 5p[1/2]₀ |
| K | 212.566 | SINGLE-PHOTON | (—) | 94092.86 | 112917.62 | 5p[1/2]₀ | Kr Ions |

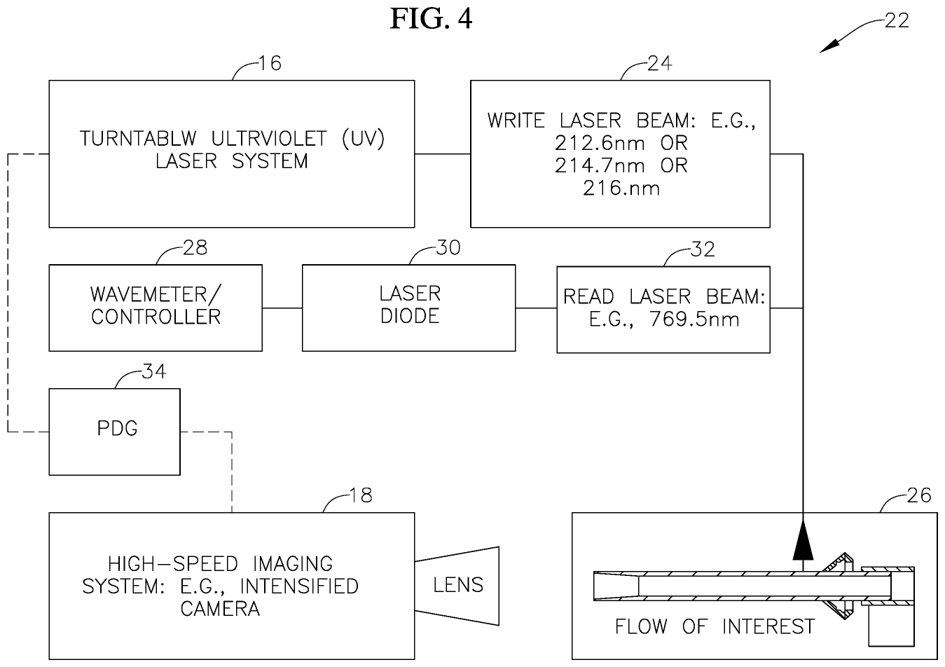

FIG. 4 is a schematic diagram of a high-speed imaging system 22 useful for practicing the present invention. The tunable ultraviolet (UV) laser system 16 outputs the write laser beam 24 to excite the atoms seeded into the flow 26. The write laser beam 24 excites the atoms seeded into the flow 26 (e.g., Kr or Ar). The Wavemeter/Controller 28 controls the operation of the continuous wave (CW) laser diode 30 which outputs the read laser beam 32. The read laser beam 32 re-excites the translated atoms that were seeded into to the flow 26 so that they may be imaged by the high-speed imaging system 22. The pulse-delay generator (PDG) 34 synchronizes the tunable UV laser system 16 and the high-speed imaging system 22. It should be understood that alternative implementations are possible and expected.

It will be understood that the embodiments described hereinabove, are merely exemplary and that a person skilled in the art may make many variations and modifications without departing from the spirit and scope of the present invention. For example, it should be noted that the aforementioned methods are not confined to high-speed (e.g., Mach 1 or greater) flows and are also applicable to slow-moving fluids.

1. A method for measuring fluid velocity, comprising the steps of:
introducing a plurality of tracer atoms into a fluid flowing in an enclosed space;
exciting a write line of said plurality of tracer atoms;
imaging said write line as a first image;
waiting for a predetermined delay period such that said write line translates in said enclosed space and becomes a read line;
imaging said read line as a second image; and
calculating the velocity of said fluid by comparing said first image to said second image.

2. The method of claim 1, wherein said plurality of tracer atoms comprises a noble gas.

3. The method of claim 2, wherein said noble gas is krypton.

4. The method of claim 2, wherein said noble gas is argon.

5. The method of claim 1, wherein said exciting step is performed with a laser.

6. The method of claim 1, wherein said imaging steps are conducted with one or more charge-coupled device cameras.

7. The method of claim 1, wherein said predetermined delay period is in a range of from about 500 nanoseconds to about 2 microseconds.

8. The method of claim 1, wherein said enclosed space is a wind tunnel.

9. The method of claim 8, wherein said wind tunnel operates at supersonic speeds.

10. The method of claim 8, wherein said wind tunnel operates at hypersonic speeds.

11. A method for measuring fluid velocity, comprising the steps of:
introducing a plurality of tracer atoms into a fluid flowing in an enclosed space;
exciting a write line of said plurality of tracer atoms;
imaging said write line as a first image;
waiting for a predetermined delay period such that said write line translates in said enclosed space and becomes a translated write line;
re-exciting said translated write line to create a read line;
imaging said read line as a second image; and
calculating the velocity of said fluid by comparing said first image to said second image.

12. The method of claim 11, wherein said plurality of tracer atoms comprises a noble gas.

13. The method of claim 12, wherein said noble gas is krypton.

14. The method of claim 12, wherein said noble gas is argon.

15. The method of claim 11, wherein said exciting and said re-exciting steps are performed with a laser.

16. The method of claim 11, wherein said imaging steps are conducted with one or more charge-coupled device cameras.

17. The method of claim 11, wherein said predetermined delay period is in a range of from about 500 nanoseconds to about 2 microseconds.

18. The method of claim 11, wherein said enclosed space is a wind tunnel.

19. The method of claim 18, wherein said wind tunnel operates at supersonic speeds.

20. The method of claim 18, wherein said wind tunnel operates at hypersonic speeds.

21. A system for measuring fluid velocity, comprising:
an enclosed space containing a moving fluid;
a source of noble gas atoms configured to be seeded as tracer atoms into said moving fluid;
a laser configured to excite said tracer atoms and produce excited tracer atoms;
at least one camera configured to image said excited tracer atoms at a plurality of locations; and
a processor, communicatively coupled to said at least one camera, said processor configured to calculate the velocity of said moving fluid.

22. The system of claim 21, wherein said noble gas atoms comprise krypton.

23. The system of claim 21, wherein said noble gas atoms comprise argon.

24. The system of claim 21, wherein said at least one camera comprises a plurality of cameras.

25. The system of claim 21, wherein said at least one camera comprises a charge-coupled device.
